(19) United States
(12) Patent Application Publication
(10) Pub. No.: US 2026/0219898 A1
(43) Pub. Date: Jul. 30, 2026

(54) COMPUTING DEVICES HAVING NAVIGATION MANAGERS FOR NAVIGATING ELEMENTS OF A COMPUTING APPLICATION AND ASSOCIATED METHODS

(71) Applicant: Lenovo Global Technology (United States) Inc., Morrisville, NC (US)

(72) Inventors: Fred Allison Bower, III, Morrisville, NC (US); Marioara-Alina Tucunete, Morrisville, NC (US); Sebastian-Andrei Puiu, Morrisville, NC (US); Alin Gigel Voinic, Morrisville, NC (US); Raul-Dumitru Gioanca, Morrisville, NC (US); Mihai-Razvan Tudorache, Morrisville, NC (US); Sergiu Stanciu, Morrisville, NC (US)

(21) Appl. No.: 19/037,369

(22) Filed: Jan. 27, 2025

(51) Int. Cl. G06F 9/451; G06F 9/445

(52) U.S. Cl. CPC G06F 9/451; G06F 9/44521

(57) ABSTRACT

Computing devices having navigation managers for navigating elements of a computing application and associated methods are disclosed herein. According to an aspect, a computing device includes a navigation manager configured to manage a user interface for navigating a plurality of dynamic elements of a computing application. Further, the navigation manager is configured to receive data indicative of user navigation and/or use of the plurality of dynamic elements of the computing application. The navigation manager is also configured to determine a score for each of the plurality of dynamic elements based on the received data indicative of the user navigation and/or use. Further, the navigation manager is configured to modify the user interface for navigating the plurality of dynamic elements of the computing application based on at least one determined score.

### TECHNICAL FIELD

The presently disclosed subject matter relates generally to navigation of computing applications. Particularly, the presently disclosed subject matter relates to computing devices having navigation managers for navigating elements of a computing application and associated methods.

### BACKGROUND

Use of websites have become one of the most common ways that people find information or other content. A website is a set of web pages and related content that is identified by a common domain name. Websites are published on one or more web servers.

Navigation of a website typically begins by entering the website's Uniform Resource Locator (URL) into a web browser. The URL is a reference to a web resource that specifies its location in a computer network so that the associated web page can be retrieved. Once the URL is entered, the web page is displayed to the user. The initial web page is generally referred to as the homepage. From the homepage, the user is often presented with a navigation bar or menu, which serves as a map, for guiding the user to different parts of the website. Web pages can also display or present interactive elements that allow users to engage with and manipulate content or functionality of the website. The user can interact with these elements by actions such as clicking, typing, dragging, hovering, and scrolling. Often interactions with a web page lead to presentation of yet another web page of the website, or a web page of a different web site.

Some websites contain a large number of web pages, and finding desired information or content can be time consuming and cumbersome. Some web browsers provide functionality for bookmarking web pages, but there are limitations because other users cannot use the bookmarks. Also, bookmarks may not carry over to new systems utilized by the user. Therefore, there is a continuing need for improved systems and techniques for searching, marking, and navigating websites.

### SUMMARY

Computing devices having navigation managers for navigating elements of a computing application and associated methods are disclosed herein. According to an aspect, a computing device includes a navigation manager configured to manage a user interface for navigating a plurality of dynamic elements of a computing application. Further, the navigation manager is configured to receive data indicative of user navigation and/or use of the plurality of dynamic elements of the computing application. The navigation manager is also configured to determine a score for each of the plurality of dynamic elements based on the received data indicative of the user navigation and/or use. Further, the navigation manager is configured to modify the user interface for navigating the plurality of dynamic elements of the computing application based on at least one determined score.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1A is a block diagram of a system including a computing device having a navigation manager for navigating elements of a computing application in accordance with embodiments of the present disclosure;

FIG. 1B illustrates a block diagram of a system including a server having a navigation manager for manipulating navigation elements of a computing application in accordance with embodiments of the present disclosure;

FIG. 2 is a flow diagram of a method for navigating elements of a computing application in accordance with embodiments of the present disclosure;

FIG. 3 is a flow diagram of a method for navigating page of an electronic publication in accordance with embodiments of the present disclosure;

FIG. 4 depicts a diagram showing the successive web pages that can be navigated in order for the user to reach a desired web page;

FIG. 5 is an example flow diagram depicting a user's session interacting with web pages of a website for arriving at a desired web page in accordance with embodiments of the present disclosure; and

FIG. 6 is a screen display showing a user interface that have been modified based on user activity in accordance with embodiments of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

As referred to herein, the term “computing device” should be broadly construed. Example computing devices include, but are not limited to, a server, a desktop computer, a laptop computer, a smart phone, a cell phone, a pager, a personal digital assistant (PDA), a mobile computer with a smartphone client, or the like.

As referred to herein, the term “computing application” (also known as simply an “app” or “application”) is a program or set of instructions residing on a computing device for performing specific tasks or solving specific problems. Examples include, but are not limited to, websites, productivity software (e.g., word processing software, spreadsheet software, and presentation software), web browsers, media players (e.g., a player for music, video, and/or images), data management software, software coding, and communication software (e.g., apps for messing, email or video conferencing).

As referred to herein, the term “user interface” is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object. Other example user interfaces include voice-activated interfaces such as, but not limited to, natural-language interfaces (NLIs). In another example, a user interface can be any suitable hardware, software, and/or firmware that enables a user to navigate dynamic elements of a computing application. Examples include a keyboard, a mouse, a touchscreen display, or any element that can be used for receiving user input for navigation of dynamic elements.

As referred to herein, the term “dynamic element” or “interactive element” can be used interchangeably and should be broadly construed. Example interactive elements include, but are not limited to, buttons, links, interactive maps, sliders, drag-and-drop features, menus, navigation bars, input fields, tabs, and search bars. A dynamic element can be any interactive or responsive component that is responsive to user actions. Example user actions include, but are not limited to, “clicking,” “hovering,” or typing.

Unless otherwise defined, all technical terms used herein have the same meaning as commonly understood by one of ordinary skill in the art to which this disclosure belongs.

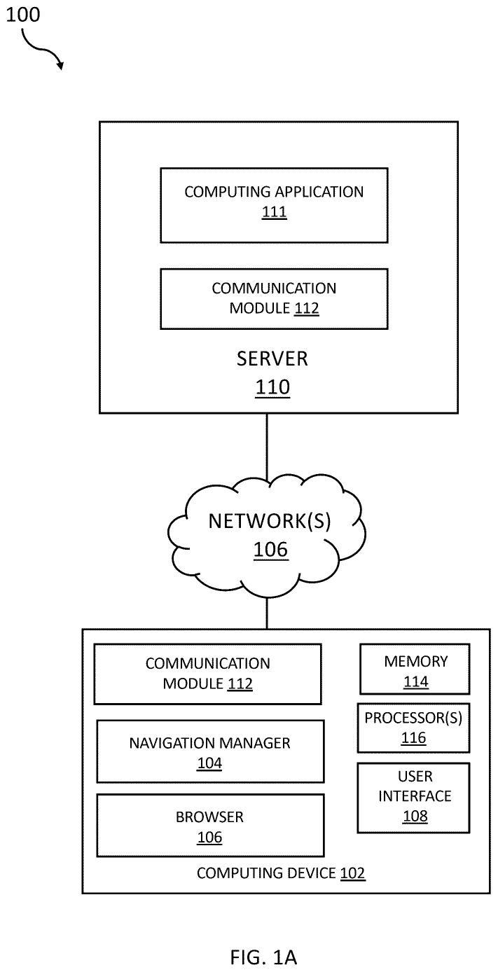

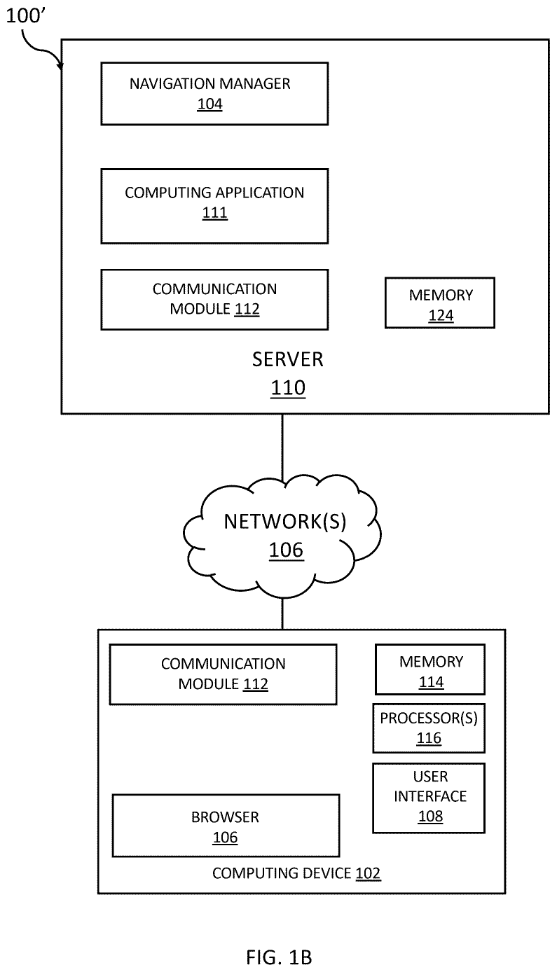

FIG. 1A illustrates a block diagram of a system 100 including a computing device 102 having a navigation manager 104 for navigating elements of a computing application in accordance with embodiments of the present disclosure. FIG. 1B illustrates a block diagram of a system 100′ including a server 110 having a navigation manager 104 for manipulating navigation elements of a computing application in accordance with embodiments of the present disclosure. Referring to FIGS. 1A and 1B, the computing device 102 can operate to run one or more computing applications for interaction by a user of the computing device. For example, a browser 106 may be a user interface that resides on the computing device 102 for assisting the user to access and interact with a computing application. Further, the browser 106 can receive user input via a user interface 108 (e.g., hardware interface such as a touchscreen display, a mouse, or keyboard). The browser 106 can also control a display of the user interface 108 of the computing device 102 to display or otherwise present text, graphics, etc. of the computing application. In an example, the browser 106 can enable the user to interact with one or more pages displayed or otherwise presented by the computing application. The browser 106 can also enable the user to select one or more dynamic elements or interactive elements of the pages such that the user can navigate to another page presented by the computing application 111 via the user interface 108.

In an example, the browser 106 can be a web browser for use to access, view, and interact with websites. The browser 106 can present pages of a website via the user interface 108. The pages can include one or more dynamic elements or interactive elements such that the user can navigate to another page of the website. Further, the user can interact with elements by actions such as clicking, typing, dragging, hovering, and scrolling.

In accordance with some embodiments, the system 100 includes a server 110 operable to provide access to a computing application 111 for interaction by the user via the computing device 102. For example, the server 110 can provide access to a website, productivity software, a media player, a data management application, and the like that resides at the server 102. Access to the computing application 111 at the server 110 can be provided via one or more communication networks The user at the computing device 102 can utilize the browser 106 to interact with and navigate the computing application 111 residing at the server 110. The computing device 102 and the server 110 can each include communication modules 112 that are operative to communicate with each other via the network(s) 106.

In accordance with embodiments, the navigation manager 104 can manage the user interface 108 and/or the computing application 111 for navigating dynamic elements of a computing application. For example, the navigation manager 104 can cooperatively interact with the browser 106 and/or function as a browser to interact with and navigate elements of the computing application 111. In an example, the computing application can be a website managed by the server 110 or an app implemented at the computing device 102.

The navigation manager 104 can receive data indicative of user navigation and/or use of dynamic elements of the computing application 111. For example, the navigation manager 104 can receive data from the user interface 108, browser 106, or otherwise receive an indication that the user has navigated the computing application 111 or otherwise used a dynamic element of the computing application 111. In an example, a webpage may be presented via the user interface 108 (e.g., displayed by the computing device's 102 display) and the user may select one of the links of the webpage to thereby navigate to another webpage. The navigation manager 104 may receive indication of this interaction and suitably store this information in memory 114. The navigation manager 104 may also receive other such information about navigation or user of dynamic elements of the computing application 111. The data of these interactions and uses may be suitably stored and indexed within memory 114. In the example of FIG. 1B, the server 110 can include a memory 124 in which its navigation manager 104 stores indications of user interactions.

Further, the navigation manager 104 can determine a score for one or more of the dynamic elements of the computing application based on the received data indicative of the user navigation and/or use of the dynamic elements. For example for each dynamic element of a website or other computing application, the navigation manager 104 can determine metrics of the user's interaction with dynamic element. The navigation manager 104 can generate data indicative of this usage. Example data includes, but is not limited to, a time of access to one of the dynamic elements, a number of accesses to one of the dynamic elements, input into one of the dynamic elements, scrolling a display of the dynamic elements, selection of a menu of one of the dynamic elements, upload of data (e.g. a file) of one of the dynamic elements, a pointer interaction with one of the dynamic elements, a sequence of interaction by the user, activation of dynamic elements, button presses, utilization of a selector for the dynamic elements, and the like.

The greater usage of a dynamic element can result in a higher score for the dynamic element. In an example, pages that are only briefly accessed for just a few seconds, typically serving as a transit route to a final destination, are filtered out and assigned lower scores, indicating their low relevance. Based on how much time the user spends on a page and how frequently this page is accessed, the score can be increased by the navigation manager 104.

The navigation manager 104 can modify a user interface for navigating the dynamic elements of a computing application based on one or more scores. For example, the user interface 108 or the computing application 111 can be controlled to present or otherwise provide access to dynamic elements having higher scores more prominently or in more places than dynamic elements having lower scores. In another example of modifying a user interface, the computing application 111 can be modified to be displayed differently or at main or primary webpages of a website such that they can be accessed more easily. As an example, a main webpage can be modified to present a dynamic element to link to another webpage that is accessed frequently.

Functionalities of the navigation manager 104 described herein may be implemented by any suitable hardware, software, and/or firmware. For example, functionalities of the navigation manager 104 may be implemented by one or more processors 116 of the computing device 102 implementing instructions stored in memory 114.

It is noted that FIGS. 1A and 1B show the navigation manager 104 as residing in either the computing device 102 and server 110. However, it should be noted that the navigation manager 104 may suitably reside in another computing device. Further, it is envisioned that different features of the navigation manager 104 may be implemented at more than one computing device.

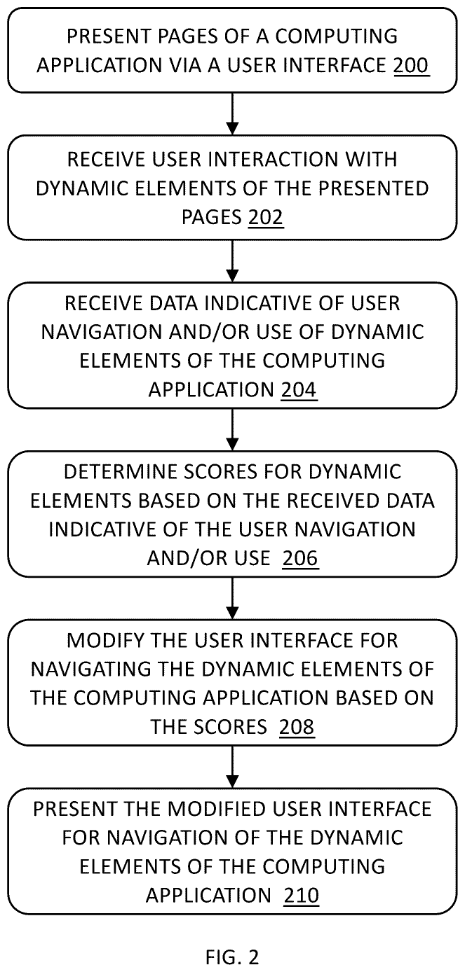

FIG. 2 illustrates a flow diagram of a method for navigating elements of a computing application in accordance with embodiments of the present disclosure. It is noted that the method is described by example as being implemented by the computing device 102 shown in FIG. 1A, although the method may alternatively be implemented by any other suitable computing device. For example, the method may be implemented by the server 110 alone or in combination with the computing device 102.

Referring to FIG. 2, the method includes presenting 200 pages of a computing application via a user interface. For example, the computing device 102 shown in FIG. 1A can present one or more pages of a website or other computing application to the user via the user interface 108. The pages can include one or more dynamic elements that may be interacted with by the user via the user interface 108. For example, the pages may be displayed via a display screen and includes one or more link buttons for navigating to other pages of the website. In an example, the navigation manager 104 can control the user interface 108 to display the link button or other dynamic elements within a GUI. In an example, the user interface can be a web user interface, and the computing application is a website. Dynamic elements can be web pages of the website. Links presented on a page can interacted with to navigate the user to other pages of the website.

The method of FIG. 2 includes receiving 202 user interaction with dynamic elements of the presented pages. Continuing the aforementioned example, the user of the computing device 102 can use the user interface 108 to interact with presented dynamic elements of a web page. For example, the navigation manager 104 or the browser 106 may control the user interface to display representations of the dynamic elements and the user may subsequently interact with the dynamic elements. For example, the user may touch the location of a dynamic element displayed on a touchscreen display or “point-and-click” a cursor to interact with the dynamic element. As a result for example, the user interface 108 can display another page associated with a link at the dynamic element in response to the interaction.

The method of FIG. 2 includes receiving 204 data indicative of user navigation and/or use of dynamic elements of the computing application. Continuing the aforementioned example, the navigation manager 104 can receive data indicative of user navigation and/or use of dynamic elements of webpages of the website. In an example, the data can indicate the number of times that the dynamic element has been utilized, such as to access another webpage.

The method of FIG. 2 includes determining 206 scores for dynamic elements based on the received data indicative of the user navigation and/or use. Continuing the aforementioned example, the navigation manager 104 can determine the score for each dynamic element of a webpage based on the user's interaction with the dynamic element. For example, each dynamic element may navigate to another webpage of a website. In this example, the navigation manager 104 can determine a score for each dynamic element based on the number of times the user used the dynamic element for navigating to another webpage. The dynamic elements may be ranked on their score, i.e., higher scores are higher in the ranking, and lower scores are lower in the ranking. Further, for example, another factor in scoring may be based on how much time the user spends on a webpage navigated to by the dynamic link. In this example, higher scores result from a high time spent by the user, and lower scores result from a low amount of time spent by the user.

The method of FIG. 2 includes modifying 208 the user interface for navigating the dynamic elements of the computing application based on the scores. Continuing the aforementioned example, initially a first set of dynamic elements may be presented to a user for navigating a website or other computing application. The navigation manager 104 or browser 106 may suitably present the first set of dynamic elements. The elements of this first set may be interacted with and scored in accordance with embodiments described herein. Subsequently, the navigation manager 104 can alter this first set of dynamic elements to a second set of dynamic elements based on the scores. For example, dynamic elements of high scores may be featured more prominently than dynamic elements of low scores. As an example, the high scorers may be displayed at an upper portion of a display screen with low scorers displayed at a lower portion. In another example, the navigation manager 104 can exclude the low scorers from presentation via the user interface 108.

The method of FIG. 2 includes presenting 210 the modified user interface for navigation of the dynamic elements of the computing application. Continuing the aforementioned example, the user may utilize the computing device in another session. The navigation manager 104 may present the modified user interface to the user via a display. For example, the high scorers may be displayed more prominently than others and/or low scorers excluded from presentation.

In accordance with embodiments, the navigation manager 104 can receive data indicative of navigation by a particular user for subsequent use in modifying a user interface for navigation as described herein. This data may be applied for use by other users having the same or a similar profile (e.g., preferences, etc.) as this first user. In response to the navigation manager 104 determining that other users have the same profile, the navigation manager 104 can modify their user interface similarly. In this way, benefits of the preferences and determined interaction behaviors of one user can be applied to other users by a navigation manager.

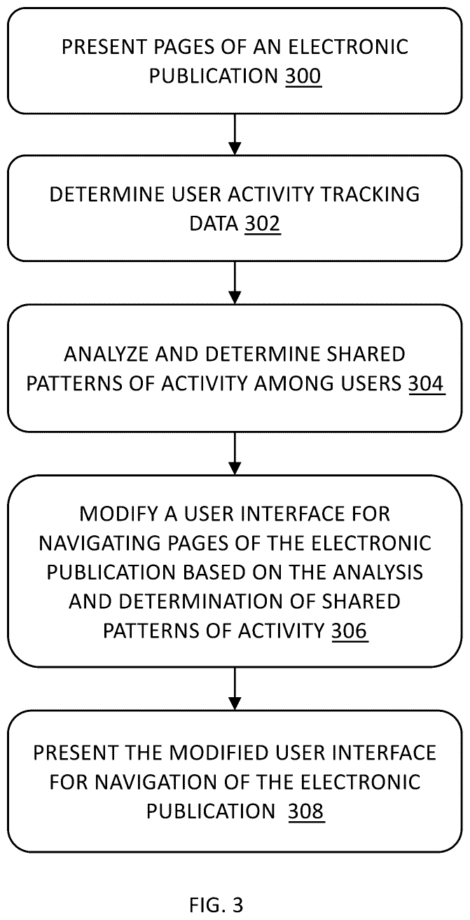

FIG. 3 illustrates a flow diagram of a method for navigating page of an electronic publication in accordance with embodiments of the present disclosure. It is noted that the method is described by example as being implemented by the computing device 102 shown in FIG. 1A, although the method may alternatively be implemented by any other suitable computing device. For example, the method may be implemented by the server 110 alone or in combination with the computing device 102.

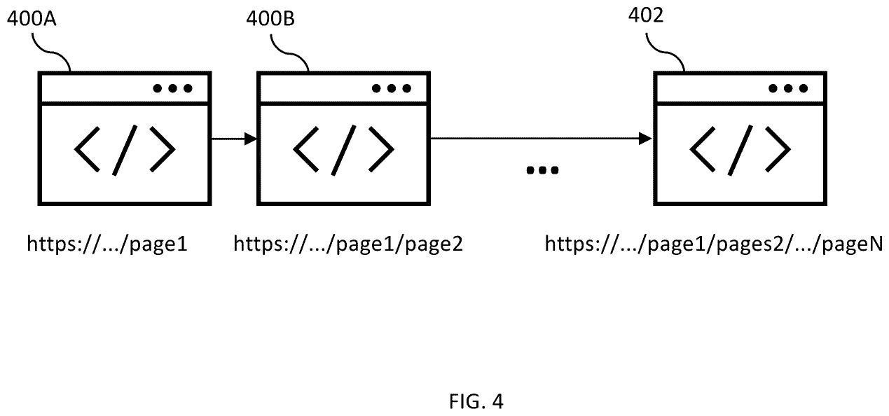

Referring to FIG. 3, the method includes presenting 300 pages of an electronic publication. For example, a user of the computing device 102 shown in FIG. 1A can utilize the computing device 102 to access a website provided by the server 110. The website includes multiple web pages that are navigable by links. In order to navigate to a desired web page, the user may interact with navigation buttons presented on the web pages. In some instances, the user may need to click on the links of multiple different web pages in order to access the desired web page. As an example, FIG. 4 depicts a diagram showing the successive web pages 400A, 400B that can be navigated in order for the user to reach a desired web page 402. In the example of FIG. 4, this may be an initial session of the user with the website.

With continuing reference to FIG. 3, the method includes determining 302 user activity tracking data. Continuing the aforementioned example, the navigation manager 104 can track user activities such as, but not limited to, navigation to other web pages, clicking on links, buttons, typing text into input fields, submission of forms, scrolling through content, entering selections from menus, uploading files, and other engagement with an application's user interface. The navigation manager 104 can log this user activity data into memory 114 or other suitable database. Further, for example, the navigation manager 104 can determine and store context information associated with these user activities. In this example, the navigation manager 104 can categorize actions occurring with a particular session, a timestamp for each action, and the like.

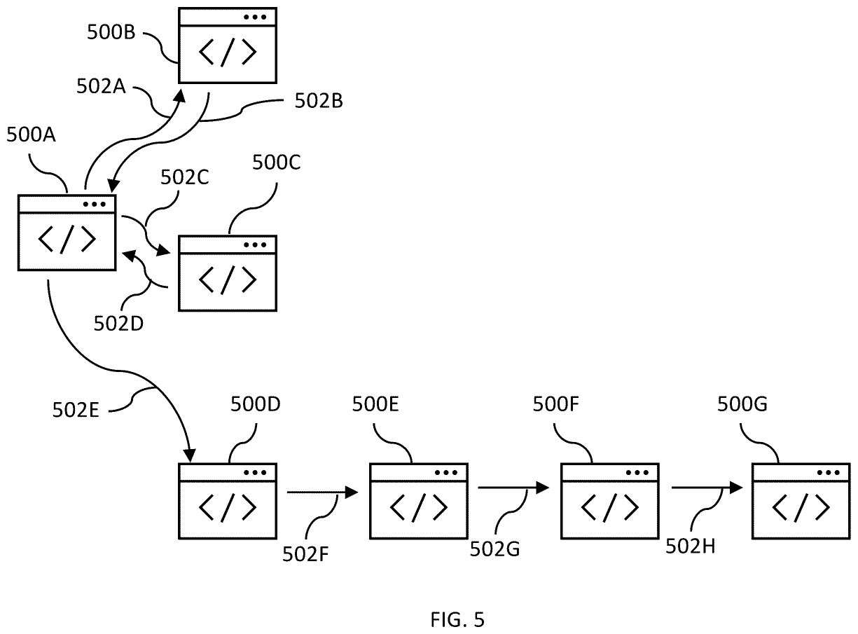

FIG. 5 illustrates an example flow diagram depicting a user's session interacting with web pages 500A-500F of a website for arriving at a desired web page 500G in accordance with embodiments of the present disclosure. Referring to FIG. 5, arrows 502A-502H indicate traversal of the web pages 500A-500F during the session. In this session, the user is seeking web page 500F and traverses the other web pages 500B-500G in order to find web page 500F. As shown in FIG. 5, the user is initially presented the main web page 500A and subsequently interacts with a link at web page 500A that leads to web page 500B. The user reviews web page 500B and determines the web page 500B does not contain the desired content. Subsequently, the user interacts with a link at web page 500B to return to the main web page 500A. Similarly, the user traverses to web page 500C, and discovers that this web page does not contain the desired content and return to web page 500A. Subsequently, the user traverses 500D, 500E, and 500F and reaches the desired web page 500G. A navigation manager (e.g., the navigation manager 102 shown in FIG. 1A) can track the user's traversal of web pages 500A-500F in the session and store the data in memory 114.

The follow table depicts example tracking data stored for the user's interactions with web pages 500A-500F shown in FIG. 5. Particularly, the table shows timestamps indicating when the user entered and exited the web pages.

| Web Page Identifier | | |
|---|---|---|
| (Reference Number) | Time Entering | Time Exiting |
| WB1 (500A) | 14:00:00 | 14:00:30 |
| | 14:00:35 | 14:00:39 |
| | 14:00:44 | 14:00:52 |
| WB2 (500B) | 14:00:30 | 14:00:35 |
| WB3 (500C) | 14:00:39 | 14:00:44 |
| WB4 (500D) | 14:00:52 | 14:00:56 |
| WB5 (500E) | 14:00:56 | 14:01:00 |
| WB6 (500F) | 14:01:00 | 14:01:06 |
| WB7 (500G) | 14:01:06 | 14:52:33 |

Example Tracking Data of User Interactions with Web Page

As indicated by the timestamp information in the table, the user spent a small amount of time (less than 10 seconds) per visit at web pages 500A-500F. In contrast, a large amount of time (greater than 50 minutes) was spent visiting web page 500G. The navigation manager 104 can analyze this time information to determine that the web page 500G was the desired destination. This determination can be made based on significantly larger amount of time spent at web page 500G as compared to the others.

It is noted that some embodiments that utilize an NLI, scoring may be implemented differently because an NLI response can generate direct-access navigation links. In these cases, the general principle of assigning importance to items that users frequently access can still apply.

Now turning again to FIG. 3, the method includes analyzing and determining 304 shared patterns of activity among users. Continuing the aforementioned example, the navigation manager 102 can receive data of multiple, different users accessing the website provided by the server 110. Each of the different users can have a unique session interacting with the website provided by the server 110. Activity data, such as web page identifier and time stamp (e.g., enter and exit times), can be acquired and stored by the navigation manager 104. Subsequently, for example, the navigation manager 104 can maintain a record for only what is relevant for each user. The navigation manager 104 can rank each of the web pages 500A-500G based on the users' interactions with the web pages 500A-500G. For example, a score may be assigned to a web page based on how much time the user spends on the web page. Also, for example, a web page's score can be changed based on how frequently the web page is accessed. A web page's score can increase the more time that is spent visiting the web page, and the more frequently the web page is visited.

The method of FIG. 3 includes modifying 306 a user interface for navigating pages of the electronic publication based on the analysis and determination of the shared patterns of activity. Continuing the aforementioned example, the navigation manager 102 can determine that one of the users is again accessing the website or otherwise using a browser. The navigation manager 104 can use a user interface to dynamically generate a menu and navigation components based on the scores or ranking of web pages. For example, links to web pages with high scores can be displayed on the menu. In another example, links to web pages with high scores can be organized in the menu according to ranking. Further, for example, web pages with low scores can be omitted from the menu.

The method of FIG. 3 includes presenting 308 the modified user interface for navigation of the electronic publication. Continuing the aforementioned example, in a subsequent session a user can use the browser 106 to access the website at the website's main page or another page. In response to the browser 106 accessing and presenting the page, the navigation manager 104 can present the modified user interface.

In accordance with embodiments, the navigation manager 104 can recognize users of different roles and share modified user interfaces among users having the same role. For example, users identified as having the same role may be employees in a company having the same or similar type of position with the company. In such instances, these users may likely benefit by use of the same modified user interface.

In an example of generating and managing user interfaces with respect to roles, for each role there can be a catalog detailing pages to which users hold permission, along with associated scores. These scores can be continuously updated based on user activity. The navigation manager can compute an average score derived from recent records, taking into account all active users, not only the last. Moreover, by use of timestamps, it can be ensured that older data does not disproportionately influence results, prioritizing the relevance of current information. Once the navigation manager has identified the most favored pages, the navigation manager can proceed to identify patterns of user activity. The navigation manager can grant users access to specific features or pages based on their roles based on the assumption that users with the same role or similar role have similar needs. The navigation manager can dynamically modify the user interface in order to prioritize the display of pages deemed as being preferred. After a user logs in, the navigation manager can detect roles associated with the user and provide a list of the user's favorite pages. Using this list as a foundation, the user interface can dynamically generate the menu and navigation components, ensuring that the most important content is easily to be accessed by the user.

In examples described herein, a navigation manager is described as being implemented by a computing device being operated by its user, such as the computing device 102 shown in FIG. 1A. However, it should be noted that a navigation manager may be suitably implemented by any other computing device having access to user interactivity with electronic publications (e.g., websites) as described herein. For example, the server 110 can receive user activity from the computing device 102, modify a user interface based on the user activity as described by examples herein, and subsequently provide data for implementing the user interface at the computing device 102 and/or other computing devices.

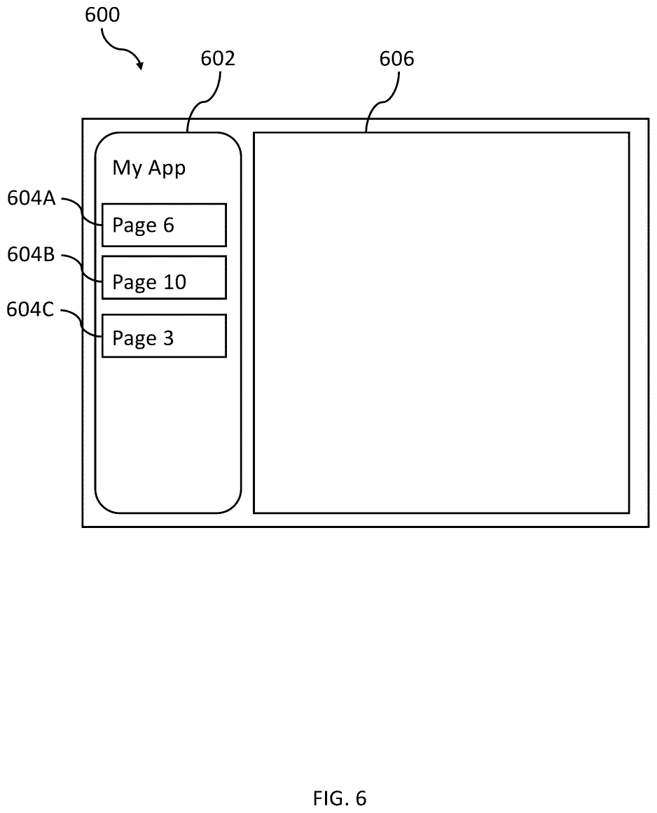

FIG. 6 illustrates a screen display showing a user interface 600 that have been modified based on user activity in accordance with embodiments of the present disclosure. Referring to FIG. 6, the user interface 600 includes a display window 602 including links 604A-604C to web pages having scores that are sufficiently high to be presented in the modified user interface. In this example, the pages meeting the score requirement are designated as Page 3, Page 6, and Page 10. Further, in this example, the links are organized from top to bottom in accordance with their scores, i.e., Page 6 has the highest score, Page 10 has the next highest score, and Page 3 has the next highest score. The user may interact with any of the links 604A-604C to result in the web page associated with the select link to be displayed at area 606. It is further noted that based on further user activity, the user interface 600 to display additional links or remove some of the displayed links in accordance with embodiments of the present disclosure.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A computing device comprising:
a navigation manager configured to:
manage a user interface for navigating a plurality of dynamic elements of a computing application;
receive data indicative of user navigation and/or use of the plurality of dynamic elements of the computing application;
determine a score for each of the plurality of dynamic elements based on the received data indicative of the user navigation and/or use; and
modify the user interface for navigating the plurality of dynamic elements of the computing application based on at least one determined score.

2. The computing device of claim 1, wherein the user interface is a web user interface, the dynamic elements are web pages, and the computing application is a website.

3. The computing device of claim 1, wherein the dynamic elements are display elements, and
wherein the navigation manager is configured to control the user interface to display the dynamic elements within a graphical user interface.

4. The computing device of claim 1, wherein the navigation manager is configured to:
manage a first set of dynamic elements for navigating the computing application; and
alter the first set of dynamic elements to a second set of dynamic elements for navigating the computing application based on the at least one determined score.

5. The computing device of claim 1, wherein the navigation manager is configured to present, via the user interface, links to a first set of the plurality of dynamic elements based on the determined scores.

6. The computing device of claim 5, wherein the navigation manager is configured to exclude from presentation, via the user interface, links to a second set of the plurality of dynamic elements based on the determined scores, and
wherein the first set of the plurality of dynamic elements is different than the second set of the plurality of pages.

7. The computing device of claim 1, wherein the data indicative of user navigation comprises user selection of a link to one of the dynamic elements of the computing application.

8. The computing device of claim 1, wherein the data indicative of use of the plurality of dynamic elements of the computing application comprises a time of access to one of the dynamic elements, a number of accesses to one of the dynamic elements, input into one of the dynamic elements, scrolling a display of the dynamic elements, selection of a menu of one of the dynamic elements, upload of data of one of the dynamic elements, a pointer interaction with one of the dynamic elements, a sequence of interaction by the user, activation of dynamic elements, button presses, and/or utilization of a selector for the dynamic elements.

9. The computing device of claim 1, wherein the received data is indicative of navigation by a first user, and
wherein the navigation manager is configured to:
determine that a second user has a profile that is the same as the first user; and
modify a user interface for the second user based on the at least one determined score and the determination that the second user has a profile that is the same as the first user.

10. The computing device of claim 1, wherein the navigation manager is configured to modify the user interface by one or more function of:
add a dynamic element for linking to one of the dynamic elements based on the at least one determined score;
remove a dynamic element for linking to one of the pages based on the at least one determined score; and
re-arrange dynamic elements for linking to the dynamic elements based on the determined scores.

11. A method comprising:
managing a user interface for navigating a plurality of dynamic elements of a computing application;
receiving data indicative of user navigation and/or use of the plurality of dynamic elements of the computing application;
determining a score for each of the plurality of dynamic elements based on the received data indicative of the user navigation and/or use; and
modifying the user interface for navigating the plurality of dynamic elements of the computing application based on at least one determined score.

12. The method of claim 11, wherein the user interface is a web user interface, the dynamic elements are web pages, and the computing application is a website.

13. The method of claim 11, wherein the dynamic elements are display elements, and wherein the method comprises controlling the user interface to display the dynamic elements within a graphical user interface.

14. The method of claim 11, further comprising:
managing a first set of dynamic elements for navigating the computing application; and
altering the first set of dynamic elements to a second set of dynamic elements for navigating the computing application based on the at least one determined score.

15. The method of claim 11, further comprising presenting, via the user interface, links to a first set of the plurality of dynamic elements based on the determined scores.

16. The method of claim 15, further comprising excluding from presentation, via the user interface, links to a second set of the plurality of dynamic elements based on the determined scores, and
wherein the first set of the plurality of dynamic elements is different than the second set of the plurality of pages.

17. The method of claim 11, wherein the data indicative of user navigation comprises user selection of a link to one of the dynamic elements of the computing application.

18. The method of claim 11, wherein the data indicative of use of the plurality of dynamic elements of the computing application comprises a time of access to one of the dynamic elements, a number of accesses to one of the dynamic elements, input into one of the dynamic elements, scrolling a display of the dynamic elements, selection of a menu of one of the dynamic elements, upload of data of one of the dynamic elements, a pointer interaction with one of the dynamic elements, a sequence of interaction by the user, activation of dynamic elements, button presses, and/or utilization of a selector for the dynamic elements.

19. The method of claim 11, wherein the received data is indicative of navigation by a first user, and
wherein the method further comprises:
determining that a second user has a profile that is the same as the first user; and
modifying a user interface for the second user based on the at least one determined score and the determination that the second user has a profile that is the same as the first user.

20. The method of claim 1, wherein modifying the user interface includes one or more of:
adding a dynamic element for linking to one of the dynamic elements based on the at least one determined score;
removing a dynamic element for linking to one of the pages based on the at least one determined score; and
re-arranging dynamic elements for linking to the dynamic elements based on the determined scores.
